(19) United States
(12) Patent Application Publication
(10) Pub. No.: US 2017/0002905 A1
(43) Pub. Date: Jan. 5, 2017

(54) Bi-directionally Acting Differential Drive Apparatuses, Systems, and Methods

(71) Applicant: Liftwave, Inc. dba Rise Robotics, Somerville, MA (US)

(72) Inventor: Blake Sessions, Somerville, MA (US)

(21) Appl. No.: 15/200,389

(22) Filed: Jul. 1, 2016

Related U.S. Application Data
(60) Provisional application No. 62/188,410, filed on Jul. 2, 2015.

(51) Int. Cl. F16H 19/06

(52) U.S. Cl. CPC F16H 19/0618; F16H 19/0631; F16H 2019/0609; F16H 2019/0627

(57) ABSTRACT

The disclosure provides apparatuses, systems, and methods for a drive assembly. The drive assembly includes a rotor body configured for rotation about a rotor axis. The rotor body includes a first portion having a first radius and a second portion having a second radius different than the first radius. The drive assembly includes a base coupled to the rotor body and including a first plurality of pulleys. The drive assembly includes a carriage coupled to the base and including a second plurality of pulleys. The carriage is configured to translate along the rotor axis with respect to the base. The drive assembly includes at least one flexible connector wound, in part, about the rotor body, about at least one pulley in the first plurality of pulleys, and about at least one pulley in the second plurality of pulleys.

### CROSS REFERENCE TO RELATED APPLICATIONS

The present application claims priority to U.S. Provisional Application No. 62/188,410 filed Jul. 2, 2015, entitled “Differential Drive Compressor Systems, Components, and Methods,” the entirety of which application is hereby incorporated herein by reference.

### TECHNICAL FIELD

The present disclosure relates to mechanical drive systems, in particular rotary-to-linear drive mechanisms.

### BACKGROUND

Windlass mechanisms are useful for their ability to produce a high degree of mechanical advantage reduction with minimal components and complexity. A significant drawback in windlass mechanism lies in their substantial bulk.

U.S. Pat. No. 9,121,481 discloses systems for motion decoupling and geometric symmetry to render a spatially compact and mechanically efficient drive mechanism that converts rotary motion to linear motion and vice versa in a “screw” form factor. While the design strategy offers many benefits in comparison to ball-screws and lead-screws, such as low cost of manufacture and robustness against environment, contamination, and shock loading, the systems are generally configured to provide positive linear work in one direction. Screw mechanisms are capable of doing work in both directions, thus doubling their potential output in some applications relative to the systems disclosed in U.S. Pat. No. 9,121,481.

### SUMMARY

Disclosed herein are methods, systems, and components for mechanisms that advantageously provide bidirectional actuation. Positive linear work may be provided in both directions of motion.

Particular embodiments provide a drive assembly including a rotor body having a rotor axis about which the rotor body is configured to rotate. The rotor body includes a first portion having a first radius and a second portion having a second radius different than the first radius. The drive assembly includes a plurality of flexible connectors comprising a first flexible connector, a second flexible connector, a third flexible connector, and a fourth flexible connector. The first flexible connector, the second flexible connector, the third flexible connector, and the fourth flexible connector are each coupled at a respective first end of the flexible connector to the first portion of the rotor body and at a respective second end of the flexible connector to the second portion of the rotor body. The first flexible connector, the second flexible connector, the third flexible connector, and the fourth flexible connector respectively are spirally wound, in part, around the first portion of the rotor body in a first direction and spirally wound, in part, around the second portion of the rotor body in a second direction. The drive assembly includes a base coupled to the rotor. The base includes a first plurality of pulleys. Each of the first flexible connector, the second flexible connector, the third flexible connector, and the fourth flexible connector are wound, in part, about a respective pulley in the first plurality of pulleys. The drive assembly includes a carriage movably coupled to the base. The carriage includes a second plurality of pulleys. The carriage is configured for bi-directional translation along the rotor axis. Each of the first flexible connector, the second flexible connector, the third flexible connector, and the fourth flexible connector are wound, in part, about a respective pulley in the second plurality of pulleys of the carriage.

In certain embodiments, the drive assembly includes a pre-loaded spring coupling a respective pulley in the first plurality of pulleys to the base.

In certain embodiments, a first spring coupling a first respective pulley in the first plurality of pulleys on a first end of the base is in compression and a second spring coupling a respective pulley in the first plurality of pulleys on a second end of the base opposite the first end is also in compression contemporaneously with the first spring being in compression.

In certain embodiments, a first plurality of windings of the first flexible connector on the first portion are interleaved with a first plurality of windings of the second flexible connector on the first portion, a second plurality of windings of the first flexible connector on the second portion are interleaved with a second plurality of windings of the second flexible connector on the second portion, a first plurality of windings of the third flexible connector on the first portion are interleaved with a first plurality of windings of the fourth flexible connector on the first portion, and a second plurality of windings of the third flexible connector on the second portion are interleaved with a second plurality of windings of the fourth flexible connector on the second portion.

In certain embodiments, the drive assembly includes a rotary actuator coupled to the base. The rotary actuator is configured to rotate the rotor body about the rotor axis. The rotary actuator can include an electric motor.

In certain embodiments, the first flexible connector, the second flexible connector, the third flexible connector, and the fourth flexible connector include a belt having a flat surface.

In certain embodiments, the first flexible connector, the second flexible connector, the third flexible connector, and the fourth flexible connector are composed at least in part of polyurethane with a steel reinforcement. The first flexible connector, the second flexible connector, the third flexible connector, and the fourth flexible connector are composed at least in part of vulcanized rubber or synthetic fibrous rope.

In certain embodiments, the drive assembly includes an electronic controller communicably coupled to the rotary actuator to control actuation of the rotary actuator.

In certain embodiments, the electronic controller is configured to reverse the direction of actuation of the rotary actuator.

In certain embodiments, the electronic controller is configured to cause the rotary actuator to rotate a pre-specified number or revolutions prior to reversing the direction of the actuator.

In certain embodiments, the drive assembly includes a rotary encoder communicably coupled to the electronic controller.

Particular embodiments provide a method of operating a drive assembly. The method includes actuating a rotary actuator coupled to a rotor body to cause the rotor body to rotate in a first direction. The rotor body has a rotor axis about which the rotor body is configured to rotate. The rotor body includes a first portion having a first radius and a second portion having a second radius different than the first radius. The rotor body includes a plurality of connectors comprising a first flexible connector, a second flexible connector, a third flexible connector, and a fourth flexible connector connected to the rotor body. The first flexible connector, the second flexible connector, the third flexible connector, and the fourth flexible connector are each coupled at a respective first end of the flexible connector to the first portion of the rotor body and at a respective second end of the flexible connector to the second portion of the rotor body. The first flexible connector, the second flexible connector, the third flexible connector, and the fourth flexible connector respectively are spirally wound, in part, around the first portion of the rotor body in a first direction and are spirally wound, in part, around the second portion of the rotor body in a second direction. The method includes causing a carriage movably coupled to a base to translate with respect to the base along the rotor axis in a first direction. The base is coupled to the rotor. The base includes a first plurality of pulleys. Each of the first flexible connector, the second flexible connector, the third flexible connector, and the fourth flexible connector are wound, in part, about a respective pulley in the first plurality of pulleys. The carriage includes a second plurality of pulleys, each of the first flexible connector, the second flexible connector, the third flexible connector, and the fourth flexible connector are wound, in part, about a respective pulley in the second plurality of pulleys of the carriage. The method includes actuating the rotary actuator coupled to the rotor body to cause the rotor body to rotate in a second direction opposite the first direction. The method includes causing the carriage to translate with respect to the base along the rotor axis in a second direction opposite the first direction.

In certain embodiments, the method includes coupling the carriage to a component for reciprocation of the component.

In certain embodiments, actuating the rotary actuator includes sending a control signal from a controller to the rotary actuator.

In certain embodiments, the method includes generating a control signal in response to receiving a signal from a sensor.

In certain embodiments, the method includes determining a position of the rotor body via a rotary encoder.

In certain embodiments, the method includes actuating the rotary actuator in response to determining the position of the rotor body by the rotary encoder.

In certain embodiments, the method includes determining a position of the carriage via a position sensor.

In certain embodiments, the method includes actuating the rotary actuator in response to determining the position of the carriage.

In certain embodiments, the method includes increasing compression in a first preloaded spring coupling a first pulley in the first plurality of pulleys to a first end of the base contemporaneously with decreasing compression in a second preloaded spring coupling a second pulley in the first plurality of pulleys to a second end of the base opposite the first end.

Particular embodiments provide a method of loading a drive assembly. The method includes applying a linear force to a carriage with a response load in a base that causes two of the four flexible connectors increase in tension while the opposing two of the four flexible connectors decreases in tension. Pre-loaded pulleys on the base (pre-loaded in compression for example) on the high-tension side of the drive will further compress the preloaded spring assemblies. The further compressed pre-loaded spring assemblies may experience a contact condition with the frame or a bottoming out that results in a “lockout” condition of the springs. The spring assemblies of the pre-loaded pulleys on the base on the low-tension side of the drive will extend (decreasing their compression) as their respective pulleys become less heavily loaded.

Particular embodiments provide a drive assembly including a rotary motor. The drive assembly includes a rotor body coupled to the rotary motor for rotation about a rotor axis. The rotor body includes a first portion having a first radius and a second portion having a second radius different than the first radius. The drive assembly includes a base coupled to the rotor body and including a first plurality of pulleys. The drive assembly includes a carriage coupled to the base and including a second plurality of pulleys. The carriage is configured to translate along the rotor axis with respect to the base. The drive assembly includes at least one flexible connector wound, in part, about the rotor body, about at least one pulley in the first plurality of pulleys, and about at least one pulley in the second plurality of pulleys.

In certain embodiments, the drive assembly includes a pre-loaded spring coupling a respective pulley in the first plurality of pulleys to the base. The pre-loaded spring can be pre-loaded in compression. The pre-loaded spring can be preloaded in tension.

In certain embodiments, the at least one flexible connector comprises a first flexible connector and a second flexible connector. A first plurality of windings of the first flexible connector is wound on the first portion and is interleaved with a first plurality of windings of the second flexible connector wound on the first portion.

Various embodiments, exploit a doubly-wound windlass form with similar windings and symmetries, in combination with spring preloading systems that maintain belt tension regardless of the state of loading of the system. These elements provide functionality for the mechanism.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawing primarily is for illustrative purposes and is not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawing, like reference characters generally refer to like features (e.g., functionally similar and/or structurally similar elements).

FIG. 1 is a perspective view of a linear drive assembly, consisting of a rotor body, belts, pulleys, a carriage movably coupled to a base, a supporting frame, preloaded spring assemblies, and an electric motor.

FIG. 2 shows a top view of the linear drive assembly of FIG. 1.

FIG. 3 shows the primary elements of the drive elements, consisting of a rotor, belts, pulleys, and preloaded spring assemblies.

FIG. 4A depicts a singular belt and its path around the rotor, redirection pulleys, and base pulley.

FIG. 4B depicts a singular belt that provides antagonistic functionality to the belt shown in FIG. 4A.

FIG. 4C depicts an antagonistic pairing of belts that provides bidirectional actuation capabilities.

FIG. 4D demonstrates the means of geometric action of the pair of belts in the drive system.

FIG. 4E depicts a full set of four belts in their two-fold rotationally symmetric arrangement.

FIG. 5 demonstrates the means of loading the system with a linear force on the carriage.

FIG. 6 depicts the loading condition that is exerted upon the rotor by the belts when the belts are subjected to a load as per FIG. 5.

The features and advantages of the inventive concepts disclosed herein will become more apparent from the detailed description set forth below when taken in conjunction with the drawings.

### DETAILED DESCRIPTION

Following below are more detailed descriptions of various concepts related to, and exemplary embodiments of, inventive systems, methods, and components of a compressor assembly.

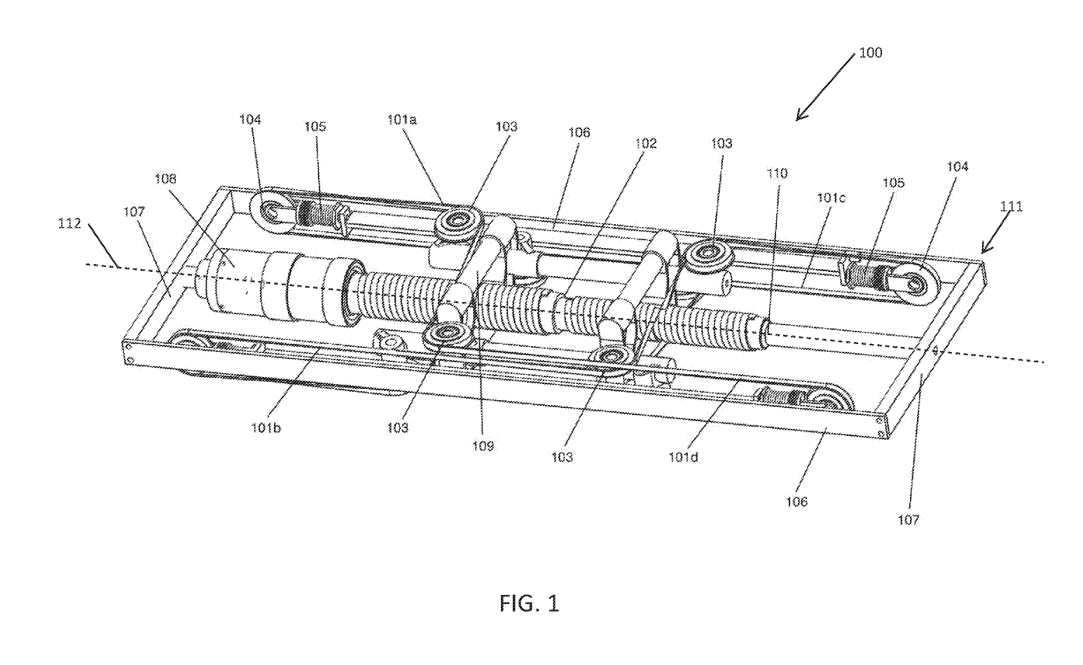

FIG. 1 depicts the linear drive assembly 100 in its entirety. The design is generally intended to be powered by a rotary electric motor 108 that applies a torque to a rotating body, rotor body 102 that has a peripheral geometry consisting of two portions having two distinct diameters. The rotor 102 is wound with at least four belts 101a-d which terminate on the rotor body 102. The belts 101a-d can include belts having a flattened surface or a rectangular cross section. The belts 101a-d can be composed at least in part of materials including, but not limited to polyurethane including a steel reinforcement, vulcanized rubber, and/or synthetic fibrous rope. At all times, each belt has a emanation along the rotor body 102, winds spirally along the rotor body 102 for some finite number of turns, exits the rotor body 102 in a tangential fashion, is redirected about a redirection pulley 103 to a direction parallel to the primary motion axis, winds around a base pulley 104, proceeds parallel to the previous leg to another redirection pulley 103, and is redirected by the redirection pulley 103 tangentially to the rotor body 102. The belt then has a finite number of winds on the alternate diameter of the rotor body 102 and has a termination point on that rotor segment.

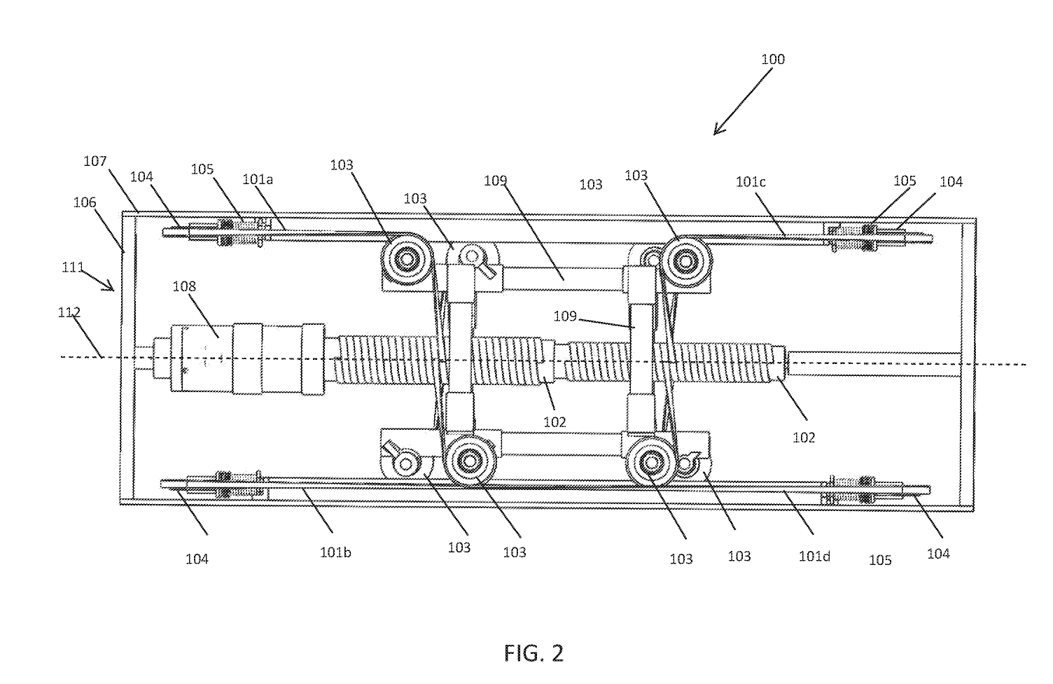

FIG. 2 shows a top view of the linear drive assembly 100. As shown in FIG. 2, the drive assembly 100 can include an electronic controller 201 including a processor configured to sending a control signal from the controller 201 to the rotary electric motor 108. The control signals can be generated in response to receiving a signal from a sensor, such as a rotary encoder 202, or a linear encoder or position sensor 203 that provides a position of the carriage 109. The sensors can be electrically connected to the controller 201 via a wired connection or they may be wirelessly communicably coupled to the controller 201.

The carriage structure 109 is linearly coupled to a base structure 111 (formed by connected rails 106 and 107) along the primary axis 112 of the drive unit 100. The rotary electric motor 108 is configured to rotate the rotor body 102 about the primary axis 112. All redirection pulleys 103 are free to rotate about pins located on the carriage structure 109, on plain bearings or ball bearings. The rail elements 106 provide a constrained linear freedom to the carriage structure 109, along the primary axis. Affixed to the frame are four preloaded spring assemblies 105, which provide compliance and the assurance of load to the base pulleys 104. Base pulleys 104 are free to travel along the primary axis, constrained by the preloaded spring assemblies and the belts which travel over the pulleys. A bearing 110 provides support to the distal end of the rotor and opposes gravitational and shock loads to the rotor body 102.

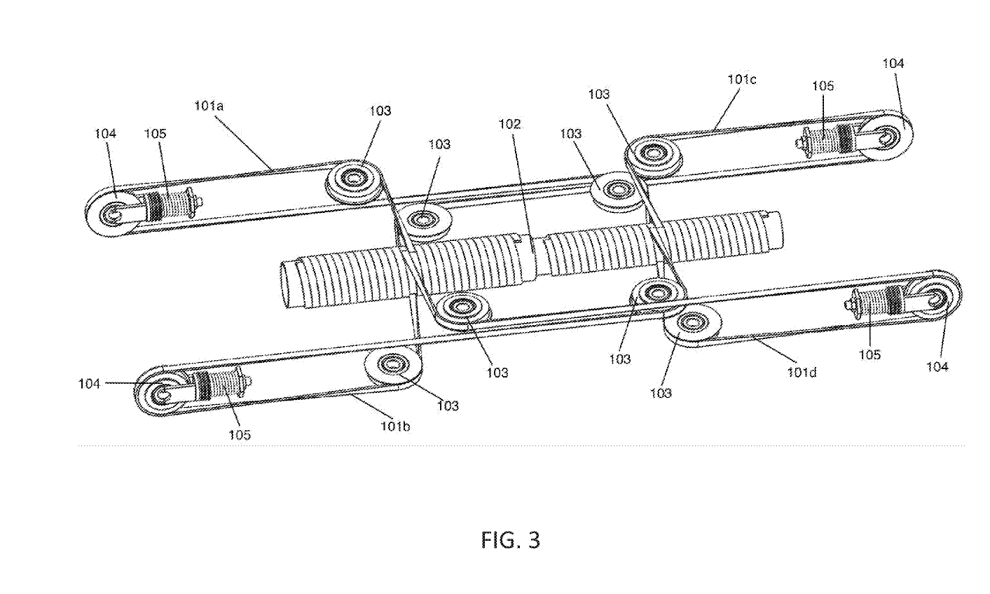

FIG. 3 shows all of the elements that are involved with the conversion of rotary power to linear power, including a rotor body 102, four belts 101a-d, eight redirection pulleys 103, four base pulleys 104, and four preloaded spring assemblies 105. The four preloaded spring assemblies 105 may all be pre-loaded in compression. In certain embodiments, the four preloaded spring assemblies 105 may all be pre-loaded in tension. The four preloaded spring assemblies 105 can include a combination of a compression spring and a Belleville spring. The four preloaded spring assemblies 105 may include one or more sensors configured to detect the deformation of the springs, which information may be used by the controller 201 to control actuation of the rotary electric motor 108.

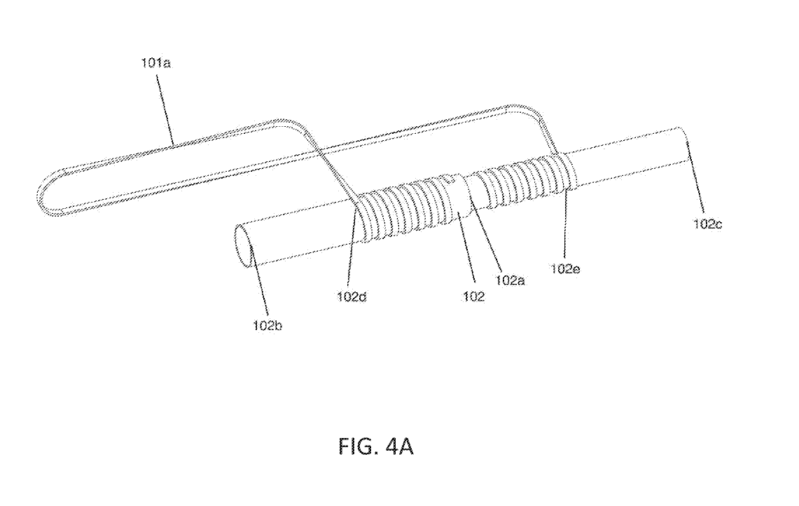

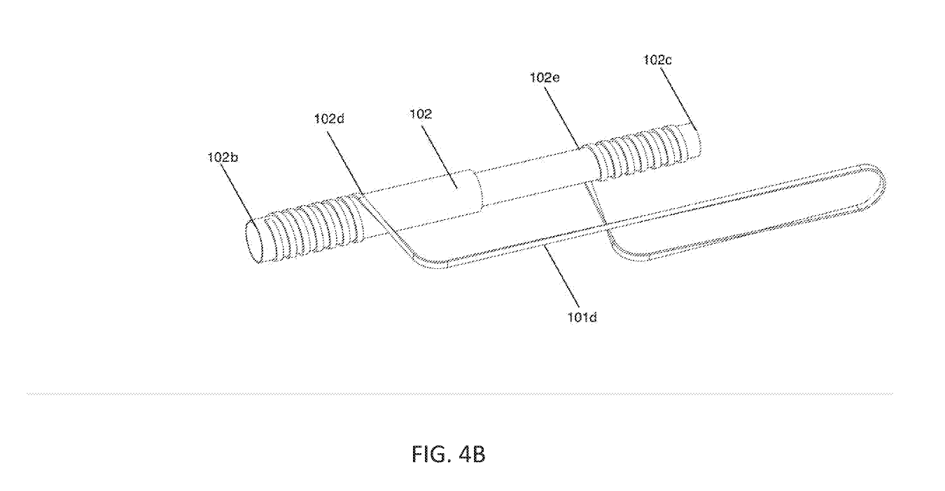

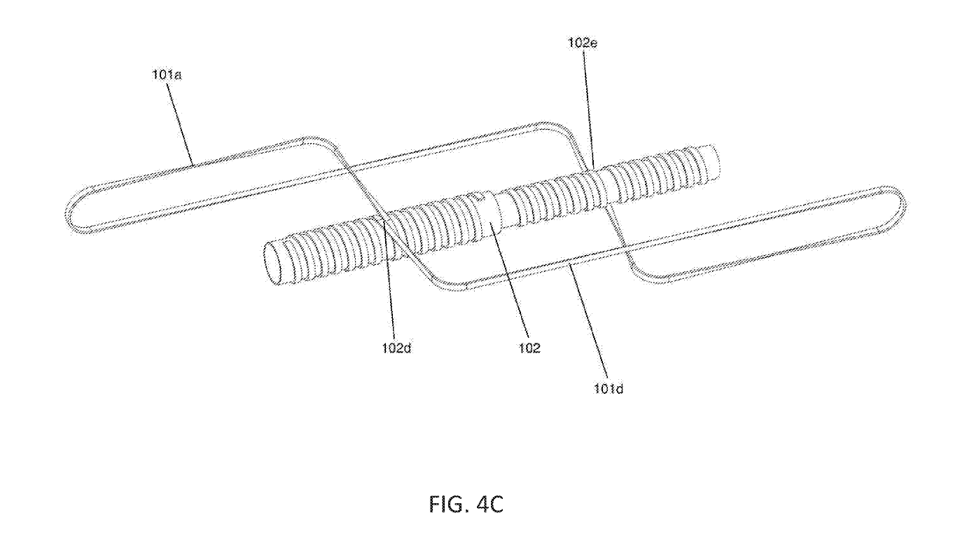

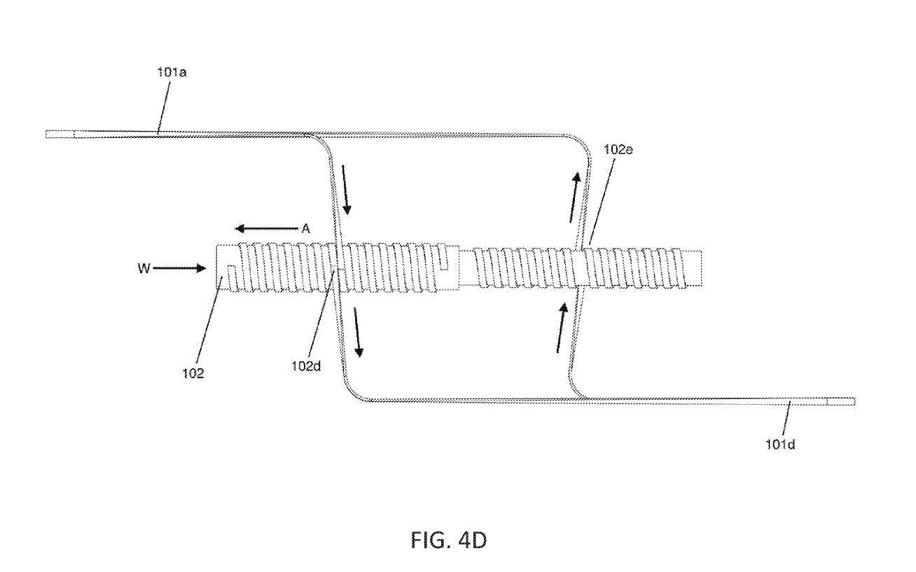

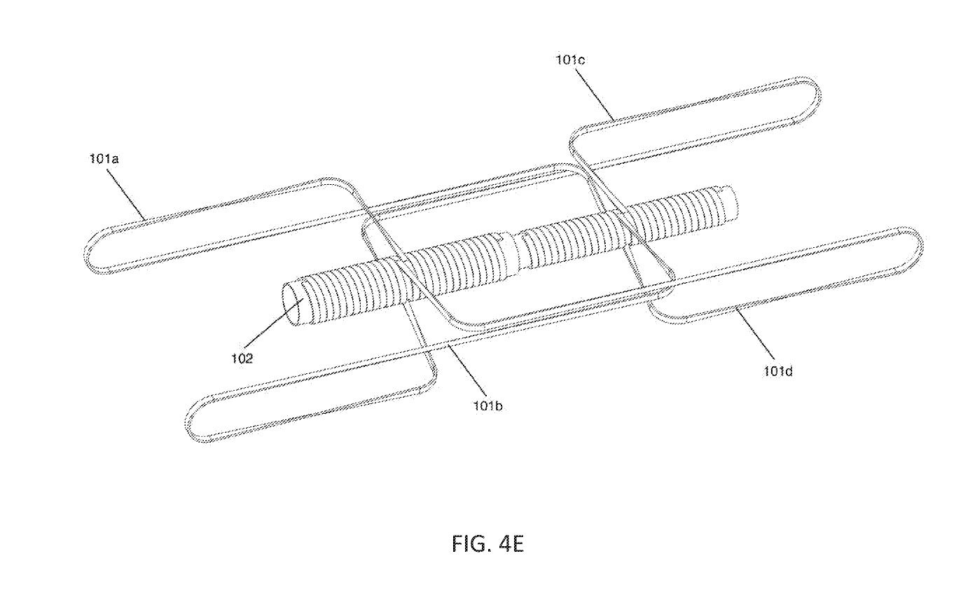

FIG. 4A depicts a singular belt segment 101a and the rotor body 102. One end of the belt resides on the large diameter of the rotor body 102 near the central point of the rotor 102a. The belt proceeds to wind around the rotor body 102 to the exit point 102d at which the belt extends tangentially to a redirection pulley 103. From the redirection pulley, the belt proceeds to a base pulley, back to a redirection pulley, and again tangentially towards the rotor body 102 at an entrance point 102e along rotor body 102. It then winds along the rotor body 102 towards the central point 102a, near which it terminates on the rotor body 102. Both ends of this belt segment 101a must terminate near the central point 102a for the design to be effective, or else the redirection pulleys 103 will not remain in the same frame of motion.

FIG. 4B depicts a singular belt segment 101d and the rotor body 102. One end of the belt resides on the large diameter of the rotor body 102 near the end of the rotor 102b. The belt proceeds to wind around the rotor body 102 to the exit point 102d at which the belt extends tangentially to a redirection pulley 103. From the redirection pulley, the belt proceeds to a base pulley in a direction opposite that of belt segment 101a, back to a redirection pulley, and again tangentially towards the rotor body 102 at an entrance point 102e along rotor body 102. It then winds along the rotor body 102 towards the opposite end 102c, near which it terminates on the rotor body 102. The ends of this belt segment 101d must terminate at their respective ends 102b and 102c for the design to be effective, or else the redirection pulleys 103 will not remain in the same frame of motion.

FIG. 4C depicts both segments 101a and 101d together with the rotor body 102. This pair of belts is an antagonist pairing, which is to say that they pull in different directions on the carriage structure 109 and thus together provide the capacity for bidirectional actuation.

FIG. 4D demonstrates the method of geometric action of this pairing of belts 101a and 101d. Rotational motion of the rotor body 102 corresponding to vector W is assumed, for the sake of argument. Segments of the belts 101a and 101d that are tangential to the rotor move in the directions indicated. The free lengths of belt segment 101a along the primary axis are growing shorter, because the belt is being ejected by the rotor at the smaller radius evident at 102e and taken up by the rotor at the larger radius evident at 102d. The associated redirection pulleys 103 are likewise traveling in the direction of vector A as the free lengths diminish. The free lengths of belt segment 101d along the primary axis are growing longer, because the belt is being ejected by the rotor at the large radius 102d and taken up by the rotor at the smaller radius 102e. The difference between these two rates of uptake and ejection, divided by two, corresponds to the rate of linear travel of the carriage structure. Because the free lengths are elongating, the corresponding redirection pulleys 103 are traveling in the direction of vector A, a motion that corresponds to the redirection pulleys 103 of belt segment 101a.

FIG. 4E depicts a full set of belts consisting of belt segments 101a, 101b, 101c, and 101d. Belt segments 101b and 101c are rotationally symmetric to belt segments 101a and 101d. As a result, their geometric action is equivalent to that of the description of FIG. 4D. The belt segments 101b and 101c provide load symmetry to the arrangement, resulting in drastically lower response loads to the rotor body 102, the frame, and the carriage 109.

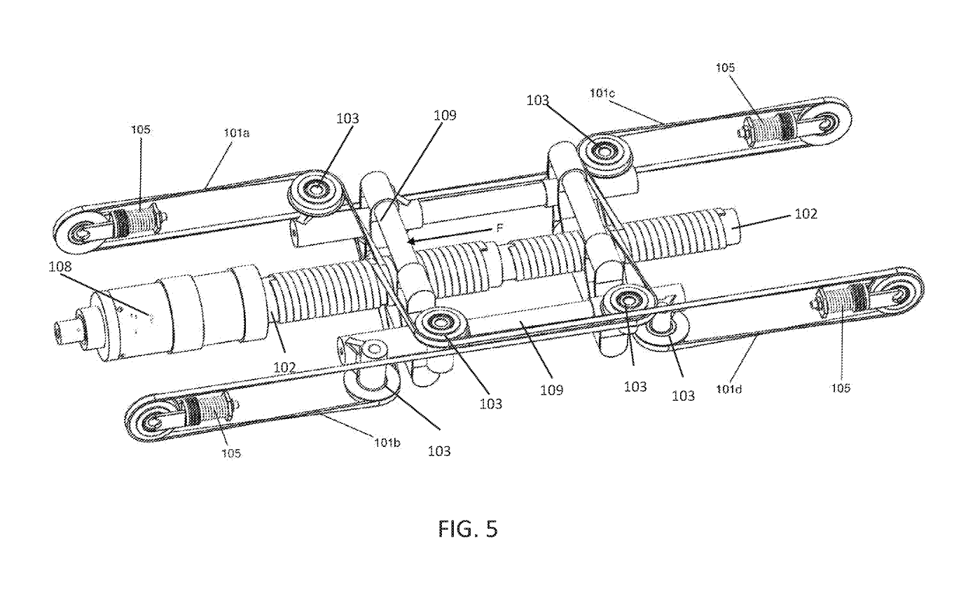

FIG. 5 depicts the method of loading the linear component of the system. A force F is applied to the carriage structure 109 along its axis of motion. This load is distributed amongst the redirection pulleys 103, resulting in a change of tension of the belt elements 101a-d. With the convention indicated, belt segments 101c and 101d are put into a higher tension state, and belt segments 101a and 101b are put into a lower tension state. The plurality of preloaded spring assemblies 105 react accordingly: Those that correspond to belts 101c and 101d are compressed further and drive those higher loads into the frame components. The preloaded spring assemblies 105 that correspond to belts 101a and 101b relax slightly and reduce the load that is applied between the base pulleys 104 and the rails 106. The difference between the loads applied to the frame components by the preloaded spring assemblies comprises the total linear load seen by the system.

If the applied load is reversed, belt segments 101a and 101b are put into a higher tension state, and belt segments 101c and 101d are put into a lower tension state. The preloaded spring assemblies corresponding to belt segments 101a and 101b are compressed further and the preloaded spring assemblies corresponding to belt segments 101c and 101d extend slightly. The opposite loading condition on the frame components ensues.

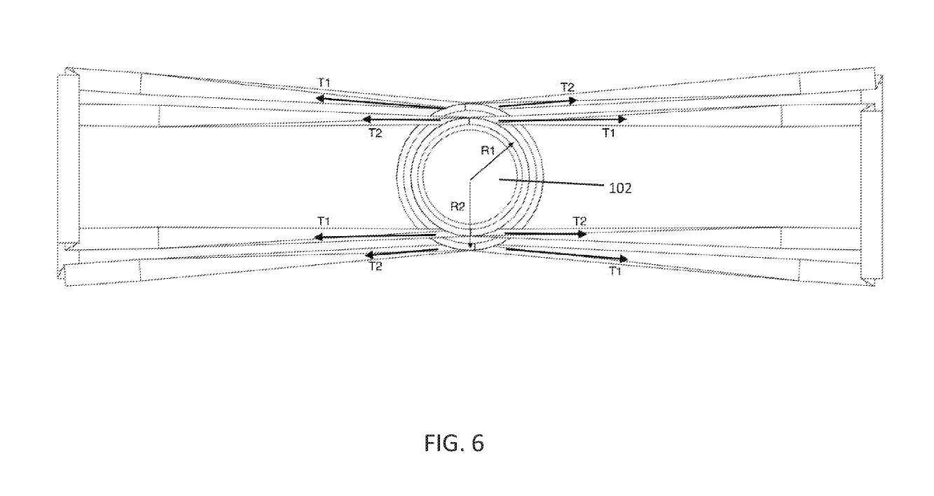

FIG. 6 depicts the loading condition exhibited in FIG. 5 on the rotor body 102 as seen from the small end of the rotor body 102. Four belt segments 101a-d with eight tangential belt segments exert their tension upon the rotor body 102. Belt segments 101c and 101d exert a higher tension upon the rotor body, depicted as equal forces T1. Belt segments 101a and 101b exert a lower tension upon the rotor body, depicted as equal forces T2 that are lower in magnitude than T1. The centerlines of the belts residing on the smaller diameter and larger diameter sections of rotor body 102 reside at radii R1 and R2, respectively. Neglecting frictional and hysteresis losses, the total clockwise torque exerted upon the rotor by the belts can then be approximated as:

Torque˜(2*T1*R1+2*T2*R2)−(2*T2*R1+2*T1*R2)

Which can be simplified to be:

Torque˜2*(T2−T1)*(R2−R1)

This arrangement of belts provides a torque to the rotor that is directly proportional to the differential of radius (R2−R1) as well as the differential of tension (T2−T1), where the latter is related linearly to the net linear load applied to the system. This makes intuitive sense, as the driving torque should increase in response to the applied load as well as a higher “lead” of the screw.

As shown in FIG. 6, the torque applied to the rotor by the belts is net counter-clockwise. The motor must then counter this torque in order to maintain equilibrium, and if it is to provide positive work, oppose the motion by providing sufficient torque to rotate the rotor body 102 in a clockwise manner. This would result in motion of the carriage to the right hand side of the frame as per FIG. 5, with positive work done to the carriage frame. Negative work can be executed if the direction of motion (of the electric motor or other rotary actuator) is reversed with the same load convention, and positive/negative work can also be applied in the opposite direction if the load convention is reversed. This design is fully capable of doing both positive and negative work in both directions of action.

As utilized herein, the terms “approximately,” “about,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of spring systems or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, describes techniques, or the like, this application controls.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Implementations of the subject matter and the operations described in this specification can be implemented by digital electronic circuitry, or via computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A drive assembly comprising:
a rotor body having a rotor axis about which the rotor body is configured to rotate, the rotor body including a first portion having a first radius and a second portion having a second radius different than the first radius;
a plurality of flexible connectors comprising a first flexible connector, a second flexible connector, a third flexible connector, and a fourth flexible connector, the first flexible connector, the second flexible connector, the third flexible connector, and the fourth flexible connector each coupled at a respective first end of the flexible connector to the first portion of the rotor body and at a respective second end of the flexible connector to the second portion of the rotor body, wherein the first flexible connector, the second flexible connector, the third flexible connector, and the fourth flexible connector respectively are spirally wound, in part, around the first portion of the rotor body in a first direction and spirally wound, in part, around the second portion of the rotor body in a second direction;
a base coupled to the rotor, the base including a first plurality of pulleys, each of the first flexible connector, the second flexible connector, the third flexible connector, and the fourth flexible connector wound, in part, about a respective pulley in the first plurality of pulleys.
a carriage movably coupled to the base, the carriage including a second plurality of pulleys, the carriage configured for bi-directional translation along the rotor axis, each of the first flexible connector, the second flexible connector, the third flexible connector, and the fourth flexible connector are wound, in part, about a respective pulley in the second plurality of pulleys of the carriage.

2. The drive assembly according to claim 1, further comprising a pre-loaded spring coupling a respective pulley in the first plurality of pulleys to the base.

3. The drive assembly according to claim 1, wherein a first spring coupling a first respective pulley in the first plurality of pulleys on a first end of the base is in compression and wherein a second spring coupling a respective pulley in the first plurality of pulleys on a second end of the base opposite the first end is also in compression contemporaneously with the first spring being in compression.

4. The drive assembly according to claim 1, wherein:
a first plurality of windings of the first flexible connector on the first portion are interleaved with a first plurality of windings of the second flexible connector on the first portion,
a second plurality of windings of the first flexible connector on the second portion are interleaved with a second plurality of windings of the second flexible connector on the second portion,
a first plurality of windings of the third flexible connector on the first portion are interleaved with a first plurality of windings of the fourth flexible connector on the first portion, and
a second plurality of windings of the third flexible connector on the second portion are interleaved with a second plurality of windings of the fourth flexible connector on the second portion.

5. The drive assembly according to claim 1, further comprising a rotary actuator coupled to the base, the actuator configured to rotate the rotor body about the rotor axis

6. The drive assembly according to claim 1, wherein the first flexible connector, the second flexible connector, the third flexible connector, and the fourth flexible connector include a belt having a flat surface.

7. The drive assembly according to claim 1, wherein the first flexible connector, the second flexible connector, the third flexible connector, and the fourth flexible connector are composed at least in part of polyurethane with a steel reinforcement.

8. The drive assembly according to claim 1, further comprising an electronic controller communicably coupled to the rotary actuator to control actuation of the rotary actuator.

9. The drive assembly according to claim 8, wherein the electronic controller is configured to reverse the direction of actuation of the rotary actuator.

10. The drive assembly according to claim 8, wherein the electronic controller is configured to cause the rotary actuator to rotate a pre-specified number or revolutions prior to reversing the direction of the actuator.

11. The drive assembly according to claim 8, further comprising a rotary encoder communicably coupled to the electronic controller.

12. A method of operating a drive assembly, the method comprising
actuating a rotary actuator coupled to a rotor body to cause the rotor body to rotate in a first direction, the rotor body having a rotor axis about which the rotor body is configured to rotate, the rotor body including a first portion having a first radius and a second portion having a second radius different than the first radius, the rotor body including a plurality of connectors comprising a first flexible connector, a second flexible connector, a third flexible connector, and a fourth flexible connector connected to the rotor body, the first flexible connector, the second flexible connector, the third flexible connector, and the fourth flexible connector each coupled at a respective first end of the flexible connector to the first portion of the rotor body and at a respective second end of the flexible connector to the second portion of the rotor body, wherein the first flexible connector, the second flexible connector, the third flexible connector, and the fourth flexible connector respectively are spirally wound, in part, around the first portion of the rotor body in a first direction and are spirally wound, in part, around the second portion of the rotor body in a second direction;
causing a carriage movably coupled to a base to translate with respect to the base along the rotor axis in a first direction, the base coupled to the rotor, the base including a first plurality of pulleys, each of the first flexible connector, the second flexible connector, the third flexible connector, and the fourth flexible connector wound, in part, about a respective pulley in the first plurality of pulleys, the carriage including a second plurality of pulleys, each of the first flexible connector, the second flexible connector, the third flexible connector, and the fourth flexible connector wound, in part, about a respective pulley in the second plurality of pulleys of the carriage;
actuating the rotary actuator coupled to the rotor body to cause the rotor body to rotate in a second direction opposite the first direction; and
causing the carriage to translate with respect to the base along the rotor axis in a second direction opposite the first direction.

13. The method according to claim 12, further comprising coupling the carriage to a component for reciprocation of the component.

14. The method according to claim 12, wherein actuating the rotary actuator includes sending a control signal from a controller to the rotary actuator.

15. The method according to claim 14, further comprising generating a control signal in response to receiving a signal from a sensor.

16. The method according to claim 12, further comprising determining a position of the rotor body via a rotary encoder.

17. The method according to claim 16, further comprising actuating the rotary actuator in response to determining the position of the rotor body by the rotary encoder.

18. The method according to claim 12, further comprising determining a position of the carriage via a position sensor.

19. The method according to claim 12, further comprising actuating the rotary actuator in response to determining the position of the carriage.

20. The method according to claim 12, further comprising increasing compression in a first preloaded spring coupling a first pulley in the first plurality of pulleys to a first end of the base contemporaneously with decreasing compression in a second preloaded spring coupling a second pulley in the first plurality of pulleys to a second end of the base opposite the first end.

21. A drive assembly comprising:
a rotary motor;
a rotor body coupled to the rotary motor for rotation about a rotor axis, the rotor body including a first portion having a first radius and a second portion having a second radius different than the first radius;
a base coupled to the rotor body and including a first plurality of pulleys;
a carriage coupled to the base and including a second plurality of pulleys, the carriage configured to translate along the rotor axis with respect to the base; and
at least one flexible connector wound, in part, about the rotor body, about at least one pulley in the first plurality of pulleys, and about at least one pulley in the second plurality of pulleys.

22. The drive assembly according to claim 21, further comprising a pre-loaded spring coupling a respective pulley in the first plurality of pulleys to the base.

23. The drive assembly according to claim 21, wherein the at least one flexible connector comprises a first flexible connector and a second flexible connector, wherein a first plurality of windings of the first flexible connector is wound on the first portion and is interleaved with a first plurality of windings of the second flexible connector wound on the first portion.
